(19) United States
(12) Patent Application Publication
(10) Pub. No.: US 2011/0293871 A1
(43) Pub. Date: Dec. 1, 2011

(54) LAMINATING FILM AND METHOD OF USING SAME

(76) Inventor: Nathan Storfer-Isser, Perrysburg, OH (US)

(21) Appl. No.: 13/117,696

(22) Filed: May 27, 2011

Related U.S. Application Data
(60) Provisional application No. 61/349,227, filed on May 28, 2010.

(51) Int. Cl. B32B 37/10; B32B 33/00; B32B 7/12

(52) U.S. Cl. 428/41.8; 156/182; 428/220

(57) ABSTRACT

The present invention relates to a substantially transparent, linerless, self-wound, pressure sensitive adhesive laminating film which is particularly useful for wide format graphics laminating applications, and a method of using same.

### RELATED APPLICATION

This application is claiming the benefit, under 35 U.S.C. 119(e), of the provisional application filed May 28, 2010 under 35 U.S.C. 111(b), which was granted Ser. No. 61/349,227. This provisional application is hereby incorporated by reference in its entirety.

### BACKGROUND

The present invention relates to a polymeric laminating film and a method of using same to laminate a graphic item. More specifically, the present invention relates to a linerless self-wound, pressure sensitive laminating film which is particularly useful for wide format graphics lamination.

Various laminating films useful for different purposes are described in the patent literature, for example:

U.S. Pat. No. 5,242,650 describes a uniaxially oriented, co-extruded, polymeric in-mold label film which includes a uniaxially hot-stretched, annealed, linerless, self-wound film having a face layer for printing and a base layer which includes a heat-activatable adhesive. The heat-shrinkability of the film is said to be balanced thickness-wise to minimize curl and allow the film to be printed in conventional label-printing presses.

U.S. Pat. No. 5,985,426 describes a packaging film having a surface providing improved release properties from cold seal adhesives. The improved cold seal release properties are said to prevent roll blocking when the film is unspooled from roll stock. The packaging film is said to find special utility in packaging of heat sensitive articles.

U.S. Pat. No. 6,376,058 describes a polypropylene-based composition which comprises a mixture of a polypropylene polymer or copolymer and an alkylene-alkyl acrylate copolymer. These compositions are said to be useful in the preparation of continuous films such as by extrusion, and the films can be oriented by stretching in the machine direction. The films made from the noted compositions are said to exhibit properties including desired printability, stiffness and die-cuttability, so as to be useful as a facestock in preparing labels, as well as an overlaminate with a functional film.

U.S. Pat. No. 6,835,462 describes a die-cuttable, biaxially stretch-oriented monolayer film comprising a polyethylene having a specified density, a polypropylene polymer or copolymer, or mixtures thereof, wherein the tensile modulus of the film in the machine direction is greater than the tensile modulus in the cross direction, and the film is free of copolymers of ethylene with an ethylenically unsaturated carboxylic acid or ester. Multi-layer films, utilizing the above-described films as a base layer, and a thermoplastic polymer skin layer bonded to the upper surface of the base layer are also described. The biaxially oriented monolayer and multilayer films are also said to be useful in particular in preparing adhesive containing labelstock.

U.S. Pat. No. 7,186,458 describes an adhesive tape comprising a backing and a layer of adhesive on the backing. The backing comprises a biaxially oriented substrate such as an isotactic polypropylene compound. The biaxially oriented substrate is preferably made from an isotactic propylene homopolymer resin having a specified melt flow rate. A method of making such a resin is also described.

Polyvinyl chloride (PVC) films are often used in the wide format graphics industry, whether cast or calendared and have a tendency to shrink up to 2% over time. Historically, overlaminate films used for surface protection of wide format graphics have also been PVC. As a result the PVC overlaminate and PVC substrate shrink together so as to minimize impact on product performance and appearance.

When a non-shrinking overlaminate is applied to a PVC substrate by means of a pressure sensitive adhesive, the shrinking of the PVC substrate generates stresses due to the resulting dimensional difference between the two layers which can cause the non-shrinking overlaminate to buckle or tunnel or cause exposure of adhesive at the edges of the overlaminate. The compressive stress generated by the shrinking of the PVC substrate may be as high as 300 MPa, but more typically is less than 200 MPa. A suitable overlaminate product must be able to resist these forces. In other words, to constrain the PVC substrate film from shrinking. The present invention is intended to overcome these issues.

It is well established that a stiff (or high cohesive strength) adhesive applied to the PVC can help constrain a PVC substrate from shrinking when applied to a stiffer substrate. In this case, the adhesive acts to transmit stresses between the layers. Based on the same principle, an adhesive of suitable stiffness matched with an overlaminate film of suitable stiffness can also constrain a PVC substrate from shrinking and thus avoid buckling of the multi-layer structure.

### SUMMARY OF THE INVENTION

The present invention relates to a substantially transparent, linerless, self-wound, pressure sensitive adhesive laminating film which is particularly useful for wide format graphics laminating applications, and a method of using same.

More particularly, the laminating film of the invention is a self-wound film preferably chosen from a polypropylene (PP) and polyethylene terephthalate (PET), but other polymeric films may be used in connection with the invention. The film is linerless, and has a stiffness expressed in terms of tensile and compressive modulus, having a tensile modulus between 0.25 GPa and 5.0 GPa in the machine direction, a tensile modulus between 0.25 GPa and 5.0 GPa in the transverse direction, a compressive modulus between 0.25 GPa and 3.0 GPa in a machine direction, and a compressive modulus between 0.25 GPa and 3.0 GPa in a transverse direction. A pressure sensitive adhesive having a cohesive strength ≧500 minutes at 1″½″×1 kg is preferably disposed on one major surface of the film, and may be adhesively bonded to at least have an adhesion value of 18 oz/in after 30 minutes and 21 oz/in after 24 hours, to a bonding surface of a graphic item by application of not less than 2 lbs/in² of pressure. The film may be applied to a graphic item directly from the roll, which has a width ≧15 in., and upon being bonded thereto preferably provides a high resolution view of the graphic item laminated. The film is preferably highly resistant to moisture and other environmental conditions during exposure to, even the outside environment, for a substantial period of time.

### BRIEF DESCRIPTION OF THE DRAWINGS

The above, as well as other advantages of the present invention, will become readily apparent to those skilled in the art from the following detailed description when considered in light of the accompanying drawings in which:

FIG. 1 shows examples of typical prior art adhesive laminating film stacks.

FIG. 1A shows a first embodiment of the laminating film stack of the invention compared to prior art adhesive laminating film stacks.

FIG. 1B shows a second embodiment of the laminating film stack of the invention compared to prior art adhesive laminating film stacks.

FIG. 2 shows a schematic view of a self-wound laminating film, generally, in accordance with the invention.

FIG. 3 shows a perspective view of a typical laminating process for a prior art laminating film.

FIG. 4 shows a perspective view of a typical laminating process suitable for use in accordance with the invention.

### DETAILED DESCRIPTION OF THE INVENTION

The present invention relates to a preferably, substantially transparent linerless, self-wound, pressure sensitive adhesive laminating film 10 which is particularly useful for wide format graphics laminating applications, and a method of using same.

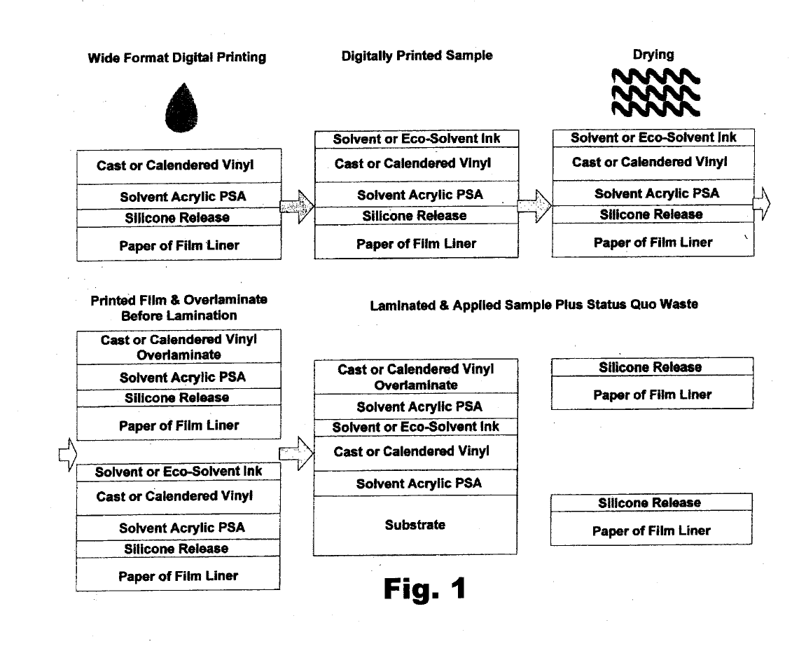

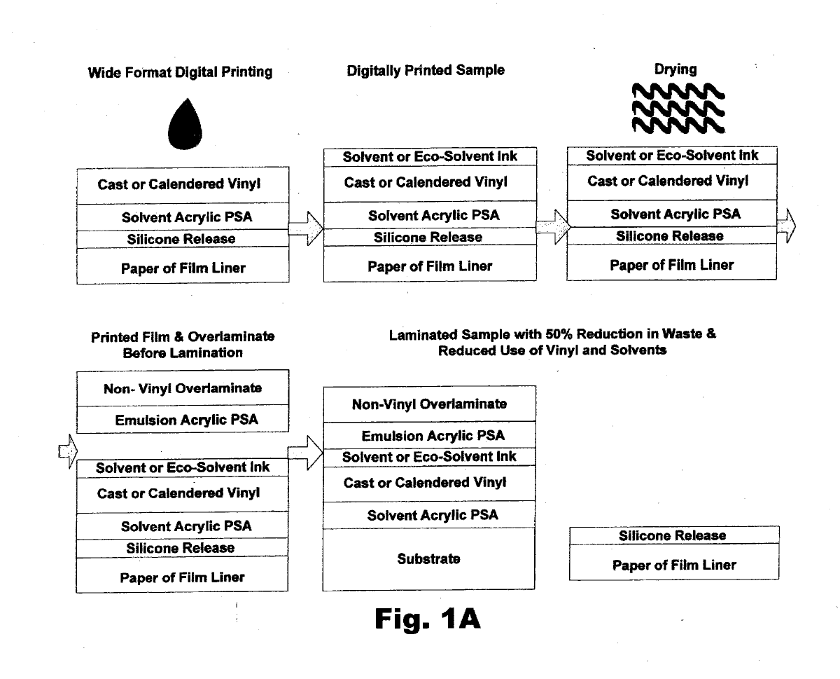

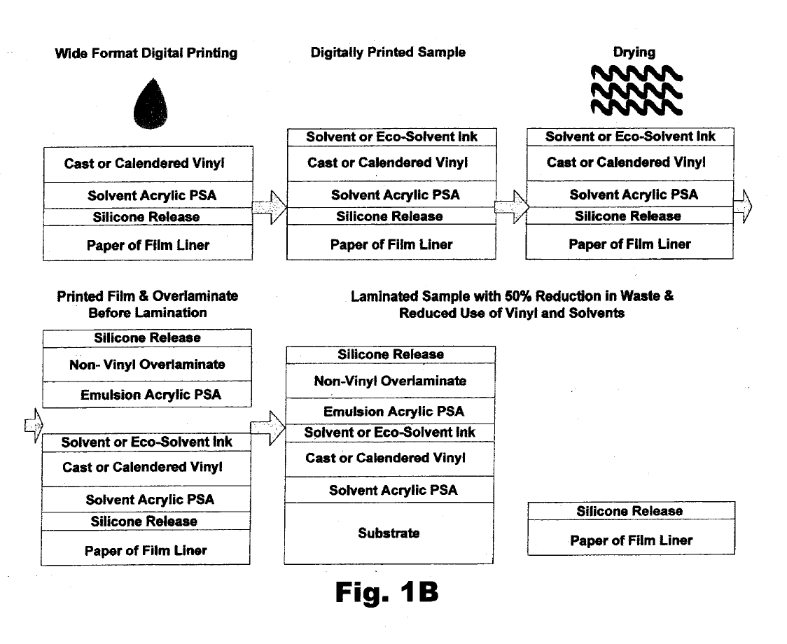

The laminating film 10 of the present invention has numerous advantages over known laminating films (see FIG. 1). For example, as illustrated in FIGS. 1A and 1B, the film 10 preferably provides a high quality view of the printed image it is protecting while providing a high level of protection against physical and chemical contaminants, being linerless, there is no liner material to dispose of, thus providing an environmental benefit, and being self-wound, with a width of at least 15 in., it may be conveniently used directly from the roll 12, for any number of laminating applications. Moreover, the film 10, preferably being one of a polypropylene and PET, is preferably highly moisture resistant, and may, by proper addition of additives, have other protective properties, such as UV radiation blocking, solvent and plasticizer resistance, and the like. For example, UV resistance can be gained through the use of benzophenones and/or hindered amine (HALS) UV stabilizers. Nanoscale zinc coatings may, for example, be used to generate a photocatalytic oxidative reaction to keep surfaces microbe free. Having a pressure sensitive adhesive disposed on a major surface of the laminating film 10 of the invention is also advantageous in that no heating or other process steps are necessary as with heat-activated adhesives.

Additionally, if a release coating is disposed on the major surface of the laminating film opposite the pressure sensitive adhesive, the potentially high decibel sound generated during unwinding of the self-wound laminating film can be reduced to levels comparable to sound levels associated with unwinding of products having a paper or film liner. Noise reduction becomes more relevant as speeds of the lamination process increase. A non-release coated roll can generate noise in excess of 120 dB. In contrast, this can be reduced to 100 dB with a medium release coating and further reduced to <80 dB with an easy release coating.

In order to realize the foregoing advantages of the laminating film 10 of the invention, the inventors have discovered that it is desirable for the film 10 to be at least 15 in. wide, so as to be capable of utilization in wide format graphics applications, such as posters, playbills, vehicle graphics, commercial graphics, point of purchase (POP) graphics, and the like. Preferably the laminating film 10 of the invention is between 36 and 60 inches wide. The material comprising the film 10 can be any suitable polymeric film, however it is preferred that it be a PET, such as 0.75 and 4 mil. thick PET films, or a polypropylene material, for example, a biaxially oriented polypropylene (BOPP) film between 1 mil and 4 mil. in thickness. Other potentially useful films could include nylon-based films, acetate films, polylactic acid (PLA) films, cellulose films, other polyethylene-based films. The inventor has found that if the material for the film 10 is a polypropylene material having two major surfaces 14, 16, a pressure sensitive adhesive, such as emulsion pressure sensitive adhesives, solvent pressure sensitive adhesives, or UV curable pressure sensitive adhesives, and having cohesive strength >500 minutes at 1″×½″×1 kg. can be advantageously utilized. Emulsion pressure sensitive adhesives are preferred. Preferably the adhesive has a cohesive strength above 1200 min. at 1″×½″×1 kg and more preferably above 1400 min. at 1″×½″×1 kg. Adhesive chemistries suitable in connection with the invention may include acrylics, silicones, urethanes or copolymers thereof. Acrylic chemistry is preferred.

One of the functions of the adhesive in the laminating system of the invention, beyond the most obvious, of bonding two surfaces together, is to constrain shrinkage by controlling the transfer of mechanical forces between, in this case, the laminating film and the substrate material. This is expressed herein by measurement of shear adhesion. For purposes of the invention, a shear adhesion >28 hours is preferred.

Additionally, the film 10 itself should have its own stiffness parameters so as to constrain any subsequent vinyl shrinkage after lamination while still remaining flexible enough to perform its intended use. For example, a stiffness expressed in terms of tensile and compressive modulus tensile modulus in a machine direction having a tensile modulus between 0.25 GPa and 5.0 GPa, and a tensile modulus in a transverse direction of between 0.25 GPa and 5.0 GPa. Preferably, film tensile modulus is between 1.0 GPa and 3.8 GPa in both the machine and transverse directions and more preferably between 1.5 GPa and 3.3 GPa in both the machine and transverse directions. The film 10 also has a compressive modulus between 0.25 GPa and 3.0 GPa in a machine direction and a compressive modulus between 0.25 GPa and 3.0 GPa in a transverse direction. Preferably, the film compressive modulus is between 0.4 GPa and 2.5 GPa in both the machine and transverse directions, more preferably between 0.6 GPa and 1.7 GPa in both the machine and the transverse directions.

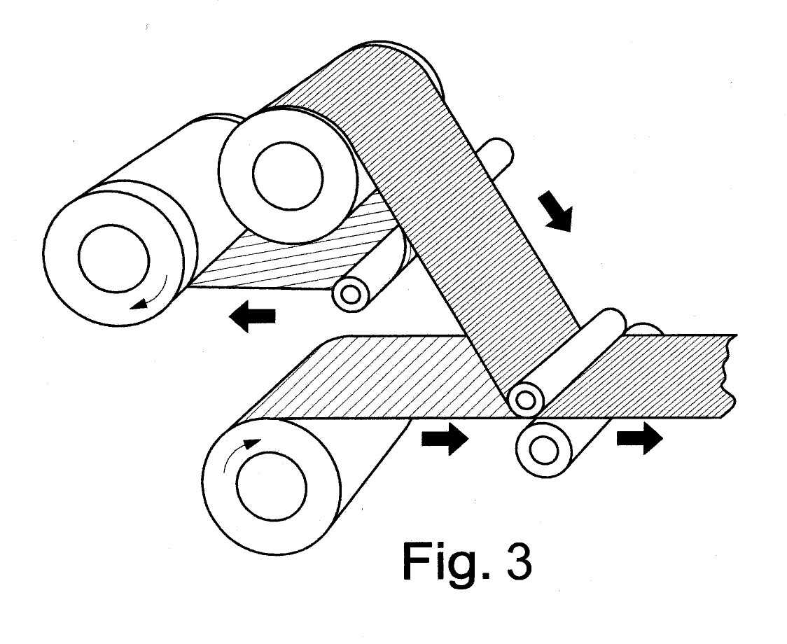

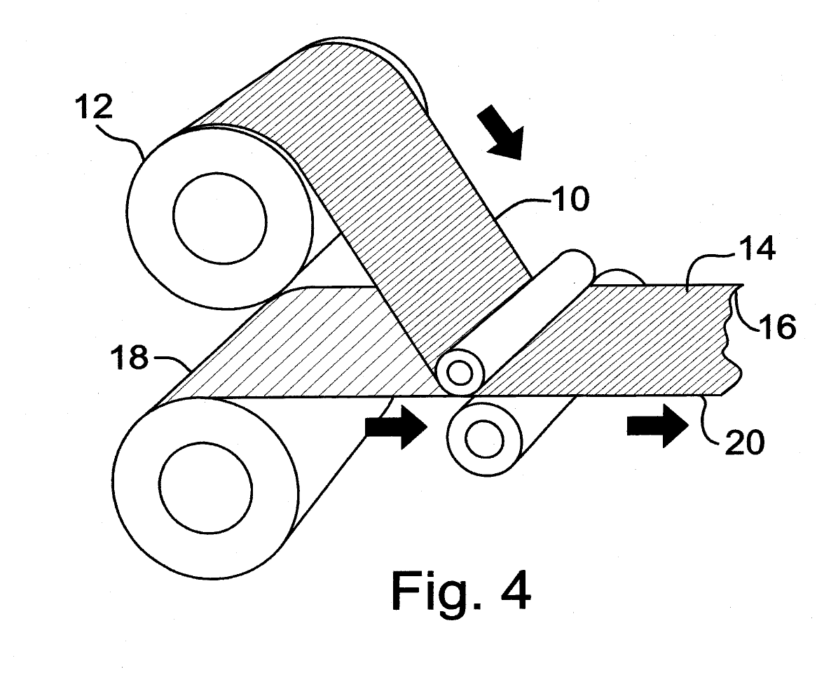

In a method of laminating using the film 10 of the invention, a predetermined length of the film 10 of the invention is unwound from a roll and the major surface having the adhesive disposed thereon is brought into contact with an item, preferably a graphic item 18 (see FIG. 4), to be laminated at adhesion values of >16 oz./in. after 30 minutes and >21 oz./in. after 24 hours. Preferably adhesion values are greater than 18 oz./in. after 30 minutes and >25 oz./in. after 24 hours, and more preferably, adhesion values are greater than 20 oz./in. after 30 minutes and >35 oz./in. after 24 hours. Either concurrently with such contact, or subsequent to complete covering of the graphic item 18 with the laminating film 10 of the invention, a sufficient amount of pressure to achieve adhesive bonding between the major adhesive surface of the laminating film 10 of the invention is uniformly applied to the film 10 thus adhering it to the graphic item 18. The amount of pressure is not less than 2 lbs/in². The relative simplicity of the laminating process of the invention shown in FIG. 4 can be appreciated by comparison with the much more complex laminating process necessary with prior art laminating films as illustrated in FIG. 3.

In one embodiment of the invention (see FIG. 1A), the laminating film is highly transparent, having a haze level less than 10%, preferably <5% and more preferably <1.5%. Such highly transparent films also typically have a surface gloss >80°, preferably >85° and more preferably >90°.

In another embodiment of the invention (see FIG. 1B), the laminating film 10 has a haze <75%, preferably <70% and more preferably <65% and is generally referred to as a matte film. Gloss for such matte finish films is typically <50°, preferably <35° and more preferably <20°. Such matte finish films can be desirable to change the aesthetic appearance of an item, eg. creating a “softer” appearance.

Protection of the surface of the laminated item 20 is an important function of the laminating film 10 of the invention. In certain configurations, the film 10 of the invention may be highly moisture resistant, chemically resistant and abrasion resistant. In such a configuration the laminating film 10 of the invention may be suitable for outdoor use, where its protective functionality remains in effect from, for example, 6 months to 3 years.

In other configurations, the film 10 of the invention may be more suitable for indoor use and is less resistant to ambient moisture conditions and the like.

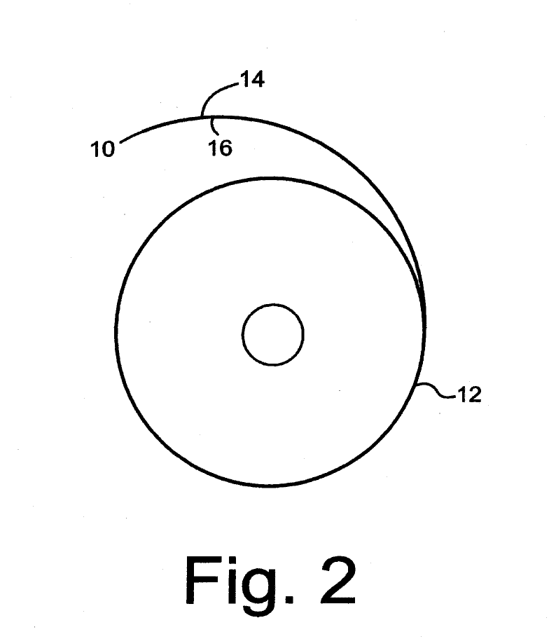

If desired, a release coating may be applied to the non-adhesive major surface of the laminating film to enhance the ease of unwinding the film 10 of the invention, as well as to reduce the sound produced in such unwinding (see FIG. 2). Suitable release coatings may include silicone and fluorinated release surface chemistries, as well as starches, polyvinyl acetates, acrylates, fluoro-acrylates, fluoro-phosphate esters, waxes, fatty acids, and polyester acrylic copolymers. Desirable release values are between 0.05 oz./in. and 12 oz./in., preferably between 0.15 oz./in. and 8 oz./in. and more preferably between 0.25 oz/in and 3 oz./in.

Other functional coatings may be applied to the non-adhesive major surface of the laminating film 10 to provide additional features, for example, anti-fog coating, dew resistant and scratch resistant coatings, anti-microbial coatings and the like.

### EXAMPLES

The applicant tested 15 films of various types, those of primary interest were polyester (PET) and polypropylene, particularly biaxially oriented polypropylene (BOPP) films. Such films are commercially available from manufacturers such as Dupont, Viafan, Exxon Mobil, SKC, Mitsubishi, Amtopp, and Loparex. In combination with these films, applicant tested 17 adhesives of various types. Of particular interest were pressure sensitive adhesives (PSA), including emulsion acrylic adhesives and acrylic/vinyl acetate blend adhesives, from adhesive manufacturers including: BASF, Avery Dennison, Cytec, Henkel, Arkema, Wacker, Dow Chemical, Franklin and Omnova. Forty-six total samples were tested. Emulsion acrylic PSAs were of particular interest, as they are environmentally friendly and are commercially available in a wide variety of different chemical compositions. It should be appreciated, however, that other adhesives may be suitable for use in connection with the invention, including acrylics or rubbers dispersed in solvent, emulsified rubbers, hotmelt rubbers or acrylics, UV curable rubbers and acrylics, and silicones.

A variety of standard tests were conducted during the evaluation of the current invention. Tensile strength and elongation was assessed using ASTM D 3759/D 3759M-05, “Standard Test Method for Breaking Strength and Elongation of Pressure Sensitive Tape”. Peel adhesion was tested after dwell times of 30 minutes and 24 hours, based on ASTM D 3330/D 3330M-04, Standard Test Method for Peel Adhesion of Pressure Sensitive Tape”. Release values for the selfwound tape were determined using ASTM D 3811/D 3811-M-96, “Standard Test Method for Unwind Force of Pressure Sensitive Tapes”. Shear adhesion was evaluated using ASTM D 3654/D 3654M-06, “Standard Test Method of Shear Adhesion of Pressure Sensitive Tapes”.

All experimentation was carried out under standard laboratory conditions, 23+/−2° C. and 50+/−5% RH. Adhesion and shear adhesion testing was performed on 18 gauge, 304 stainless steel with a bright annealed finish. Film haze and gloss values are based on self reporting of the film suppliers but could be tested using ASTM D 1003-00, “Standard Test Method for Haze and Luminous Transmittance of Transparent Plastics”.

In order to meet the objectives set out by the inventor for the laminating film of the invention, important film properties include: tensile modulus (Young modulus) 1.5 GPa>X>3.3 GPa in both the machine and the transverse directions, compressive modulus 0.25 GPa-3.0 GPa in both the machine and the transverse directions, an adhesion value (30 min.)>20 oz./in., an adhesion value (24 hr.)>35 oz./in., a release value <3.0 oz./in., and a shear adhesion value >28 hours.

It should be noted that compressive modulus values are calculated values, since measurement of compressive modulus requires very expensive and sophisticated equipment not available to the inventor. Visual observation of the samples included in Tables 1 and 2 herein confirmed that buckling or tunneling of the laminating films tested did not occur, thus empirically confirming applicants calculated range for compressive modulus.

TABLE 1

| | | | Adhesion | Adhesion | | | | |
|---|---|---|---|---|---|---|---|---|
| | Tensile | Compressive | Value | Value | Release | Shear | | |
| | Modulus | Modulus (calc) | (30 min) | (24 hr) | Value | Adhesion | Film | Adhesive |
| Example | (GPa) | (GPa) | (oz./in.) | (oz./in) | (oz./in.) | (hours) | Type | Type |
| 1 | 3.06 | 0.25-3.0 | 23.1 | 37.6 | 0.4 | 39.2 | PET | EA PSA |

It can be observed from Table 1 and the following Table 2, that of the 13 samples reported from the total 46 samples tested utilizing combinations of 15 films and 17 adhesives, only Example 1 exhibited all of the desired properties set forth in the preceding paragraphs regarding tensile modulus, compressive modulus, adhesion value (30 min and 24 hr.), shear adhesion and release value. For purposes of Tables 1 and 2, EA PSA denotes “emulsion acrylic pressure sensitive adhesive.”

TABLE 2

| | | | Adhesion | Adhesion | | | | |
|---|---|---|---|---|---|---|---|---|
| | Tensile | Compressive | Value | Value | Release | | Shear | |
| Comparative | Modulus | Modulus (calc) | (30 min) | (24 hr) | Value | Film | Adhesion | Adhesive |
| Example | (GPa) | (GPa) | (oz./in.) | (oz./in) | (oz./in.) | Type | (hours) | Type |
| C1 | 3.25 | 0.25-3.0 | 14.7 | 21.4 | 0.3 | PET | 28.1 | EA PSA |
| C2 | 2.88 | 0.25-3.0 | 18.5 | 19.5 | 6.6 | PET | 13.1 | EA PSA |
| C3 | 1.93 | 0.25-3.0 | 14.4 | 21.0 | 9.8 | BOPP | 28.1 | EA PSA |
| C4 | 1.76 | 0.25-3.0 | 14.9 | 20.5 | 9.7 | BOPP | 9.9 | EA PSA |
| C5 | 3.25 | 0.25-3.0 | 2.0 | 11.3 | 2.6 | PET | 6.9 | EA PSA |
| C6 | 2.33 | 0.25-3.0 | 10.8 | 16.4 | 5.4 | BOPP | 17.5 | EA PSA |
| C7 | 1.26 | 0.25-3.0 | 16.2 | 25.2 | 0.4 | BOPP | 5.8 | EA PSA |
| C8 | 2.21 | 0.25-3.0 | 17.6 | 28.5 | 3.2 | BOPP | 20.5 | EA PSA |
| C9 | 1.56 | 0.25-3.0 | 16.5 | 22.2 | 9.2 | BOPP | 21.4 | EA PSA |
| C10 | 1.65 | 0.25-3.0 | 18.3 | 26.3 | 0.8 | BOPP | >264 | EA PSA |
| C11 | 3.14 | 0.25-3.0 | 20.2 | 26.4 | 10.7 | PET | 11.9 | EA PSA |
| C12 | 2.17 | 0.25-3.0 | 17.6 | 28.5 | 3.8 | BOPP | 20.5 | EA PSA |

By way of contrast, comparative Examples C1-C12 do not exhibit one or more of the desired properties as set forth herein. In particular, both 30 min. and 24 hr. adhesion values are generally well below the adhesion values of Example 1. It can also be observed that the release values for C1-C12 are in many instances well above the 3.0 oz/in. desired criteria, and most exceed the release value of 0.4 oz./in. exhibited by Example 1. With regard to shear adhesion, C1 and C3 barely exceeds the 28 hr. criteria, C10 greatly exceeds the 28 hr criteria, however, all of the other comparative examples fall well short of the desired shear adhesion criteria.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are the scope of the invention as determined by the appended claims when interpreted in accordance with the breadth to which they are fairly, legally and equitably entitled.

What is claimed:

1. A method of laminating a graphic item, comprising:
providing a linerless laminating film from a roll at least 15 in. in width, the film comprising one chosen from the group consisting of a polypropylene and a polyester; the film having two major surfaces opposed one to the other, a pressure-sensitive adhesive having a cohesive strength ≧500 minutes at 1″×½″×1 kg., being disposed on one major surface of the film; the film having a tensile modulus of between 0.25 GPa and 5.0 GPa in both a machine and a transverse direction, and a compressive modulus of between 0.25 GPa and 3.0 GPa in both a machine and a transverse direction;
unwinding a predetermined length of the film from the roll, and bringing the surface having the pressure-sensitive adhesive disposed thereon into bonding contact at an adhesion value of at least 16 oz./in. after 30 minutes and at least 21 oz./in. after 24 hours with a bonding surface of a graphic item; and
uniformly applying a sufficient amount of pressure, but not less than 2 lbs/in² of pressure, to the laminating film so as to adhere it to the bonding surface of the graphic item.

2. The method defined in claim 1, wherein a release coating is disposed on the major surface of the laminating film opposite the adhesive surface.

3. The method defined in claim 1, wherein the laminating film comprises one or more additives capable of imparting an additional property to the laminating film.

4. The method defined in claim 1, wherein the width of the laminating film is ≧36 in. and ≦60 in.

5. The method defined in claim 1, wherein the thickness of the laminating film is between 1 mil. and 4 mil.

6. The method defined in claim 1, wherein the pressure sensitive adhesive comprises one chosen from the group consisting of emulsion pressure sensitive adhesives, solvent pressure sensitive adhesives and UV curable pressure sensitive adhesives.

7. The method defined in claim 6, wherein the pressure sensitive adhesive comprises an emulsion PSA.

8. The method defined in claim 1, wherein the pressure sensitive adhesive has a cohesive strength >1200 min. at 1″×½″×1 Kg.

9. The method defined in claim 1, wherein the adhesive chemistry comprises one chosen from the group consisting of acrylics, silicones, urethanes and copolymers thereof.

10. The method defined in claim 1, wherein the tensile modulus of the laminating film is between 1.0 GPa and 3.8 GPa in both the machine and transverse directions.

11. The method defined in claim 10, wherein the tensile modulus of the laminating film is between 1.5 GPa and 3.3 GPa in both the machine and transverse directions.

12. The method defined in claim 1, wherein the compressive modulus of the laminating film is between 0.4 GPa and 2.5 GPa in both the machine and transverse directions.

13. The method defined in claim 12, wherein the compressive modulus of the laminating film is between 0.6 GPa and 1.7 GPa in both the machine and transverse directions.

14. The method defined in claim 1, wherein the adhesive surface of the predetermined length of unwound laminating film is brought into bonding contact with the bonding surface of the graphic item at an adhesion value of >18 oz./in. after 30 minutes and >25 oz./in after 24 hours.

15. The method defined in claim 14, wherein the adhesive surface of the predetermined length of unwound laminating film is brought into bonding contact with the bonding surface of the graphic item at an adhesion value of >20 oz/in. after 30 minutes and >35 oz./in. after 24 hours.

16. The method defined in claim 2, wherein the release coating comprises one chosen from the group consisting of: silicones, fluoro-acrylates, fluoro-phosphate esters, starches, polyvinyl acetates, acrylates, waxes, fatty acids and polyester acrylic copolymers.

17. The method defined in claim 2, wherein the release coating has a release value between 0.05 oz./in. and 12 oz./in.

18. The method defined in claim 17, wherein the release coating has a release value between 0.15 oz./in. and 8 oz./in.

19. A laminating film comprising:
a self-wound, linerless film at least 15 in. wide, formed of a polymer comprising one chosen from the group consisting of a polypropylene and a polyethylene, having two major surfaces, opposed one to the other, on one major surface is disposed a pressure-sensitive adhesive having a cohesive strength ≧500 minutes at 1×½″×1 kg.; and
the polypropylene or polyethylene polymer having a tensile modulus between 0.25 GPa and 5.0 GPa in both a machine direction and a transverse direction, and a compressive modulus between 0.25 GPa and 3.0 GPa in both a machine direction and a transverse direction; wherein the laminating film is suitable for bonding to the surface of a graphic item.

20. The laminating film defined in claim 19, wherein the film has a haze level <10%.

21. The laminating film defined in claim 20, wherein the film has a surface gloss >80°.

22. The laminating film defined in claim 19, wherein the film has a haze level >10% and <75%.

23. The laminating film defined in claim 22, wherein the film has a surface gloss <50°.

24. The laminating film defined in claim 19, wherein the pressure-sensitive adhesive exhibits a shear adhesion >28 hrs.

25. The laminating film defined in claim 19, wherein a release coating is disposed on the major surface of the film opposite the adhesive major surface.

26. The laminating film defined in claim 19, wherein the film further comprises a non-release functional coating chosen from the group consisting of: an anti-fog coating, a dew resistant coating, a scratch resistant coating and an anti-microbial coating.

27. The laminating film defined in claim 19, wherein the film comprises one or more additives.
